(19) United States
(12) Patent Application Publication
(10) Pub. No.: US 2010/0009025 A1
(43) Pub. Date: Jan. 14, 2010

(54) MOLD FOR PATTERN TRANSFER

(76) Inventor: Masahiro Katsumura, Tsurugashima-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/294,822

(22) PCT Filed: Mar. 22, 2007
(86) PCT No.: PCT/JP2007/055846

§ 371 Date: Nov. 7, 2008

(30) Foreign Application Priority Data
Mar. 27, 2006 (JP) 2006-086007

(51) Int. Cl. B29C 43/02

(52) U.S. Cl. 425/470

(57) ABSTRACT

A mold of this invention comprises a base portion, and a pattern portion provided so as to protrude from a main face of the base portion, the base portion and the pattern portion being formed from different materials. By this means, a mold with the rigidity to withstand pressing forces during pattern transfer is provided.

### TECHNICAL FIELD

This invention relates to a mold to form patterns in a resin film using an imprinting method.

### BACKGROUND ART

Nanoimprint processes are attracting attention as technology for mass production of high-density semiconductor devices, magnetic recording devices, MEMS, next-generation recording media, and other fine-machined items. In this technology, by curing a resin in a molten state applied onto a substrate while pressing on the resin with a mold (transfer die), a relief shape with dimensions of several tens to several hundreds of nm, formed in one face of the mold, is transferred to the resin. Methods are broadly divided into thermal nanoimprint methods and photo-nanoimprint methods, according to the method of resin curing used (see, Patent Reference 1 and Non-patent Reference 1).

In the above-described nanoimprint processes, when pressing the pattern face of the mold against the resin during transfer, the relief pattern of the pattern portion is sometimes deformed due to the pressure. Further, when plating processing onto the relief pattern or similar is performed in order to avoid such deformation, time is necessary for this processing, and moreover warping of the mold itself sometimes occurs.

On the other hand, because a mold used in photo-nanoimprint methods is required to have optical transparency, in addition to the strength to withstand pressure, it has been difficult to select an appropriate material.

Patent Reference 1: Japanese Patent Application Laid-open No. 2004-148494

Non-patent Reference 1: S. Y. Chou et al., Appl. Phys. Lett. 67, 3314 (1995)

### DISCLOSURE OF THE INVENTION

The above problem is presented as an example of the problems to be solved by the present invention; an object of the present invention is to provide a mold having rigidity sufficient to withstand pressing forces during pattern transfer.

In order to attain this object, a mold of this invention is a mold comprising a base portion, and a pattern portion provided so as to protrude from a main face of the base portion, and is characterized in that the base portion and the pattern portion are made of different materials.

### BRIEF DESCRIPTION OF THE DRAWINGS

FIG. 1 is a cross-sectional view of the mold of a first embodiment of the invention;

FIG. 2 illustrates thermal nanoimprint processes;

FIG. 3 illustrates forces acting on protruding portions of a pattern portion;

FIG. 4 illustrates a method of manufacture of the mold of the first embodiment of the invention;

FIG. 5 is a cross-sectional view of a substitute example of the mold of the first embodiment of the invention;

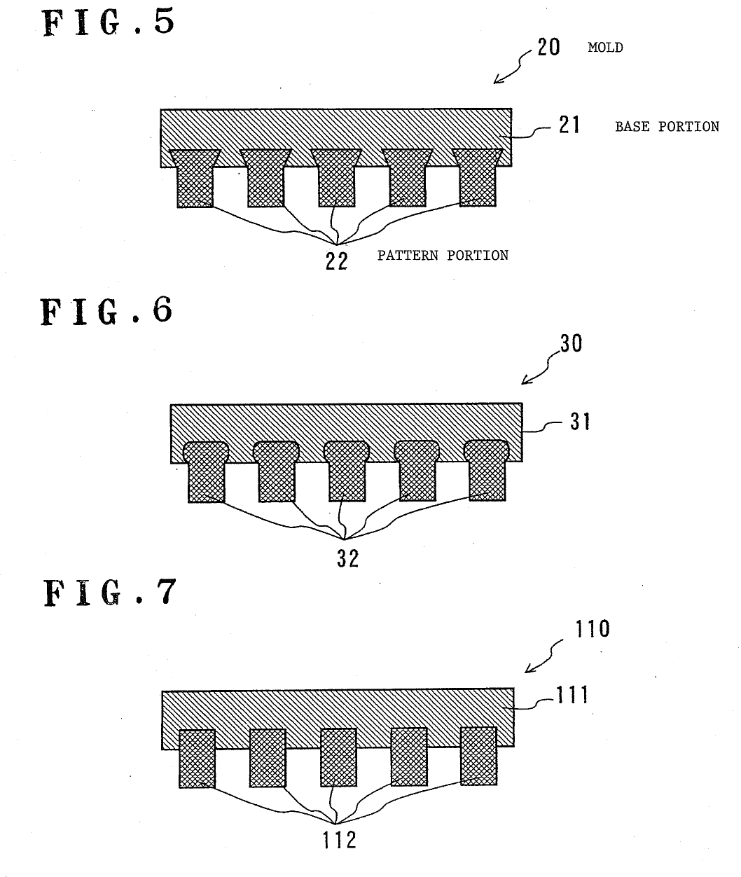

FIG. 6 is a cross-sectional view of another substitute example of the mold of the first embodiment of the invention;

FIG. 7 is a cross-sectional view of the mold of a second embodiment of the invention;

FIG. 8 illustrates photo-nanoimprint processes;

FIG. 9 illustrates a method of manufacture of the mold of the second embodiment of the invention;

FIG. 10 is substantially a plane view of a hard disk;

FIG. 11 illustrates processes to manufacture a hard disk using the mold of the first embodiment of the invention; and,

FIG. 12 summarizes a nanoimprint device.

10, 20, 30, 110 Mold (transfer die)
11, 21, 31, 111 Base portion
12, 22, 32, 112 Pattern portion
15, 115 Resist
151, 51 Substrate
152, 52 Resin
220 Hard disk
300 Thermal nanoimprint device

### BEST MODE FOR CARRYING OUT THE INVENTION

Below, a mold to form a pattern in a molten-state resin film of an aspect of the invention is described, referring to the attached drawings.

### First Embodiment

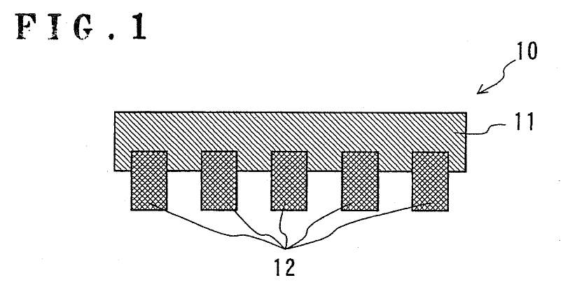

FIG. 1 shows a summary cross-sectional view of the mold 10 of a first embodiment of the invention. The mold 10 comprises a base portion 11, having a flat main face, and a pattern portion 12, provided so as to protrude from the main face of the base portion 11; by this means, the pattern portion 12 forms a relief shape in the main face of the base portion 11. The mold 10 of the first embodiment is characterized in being used for transfer when the molten-state resin film is a thermoplastic resin, and in particular, when transfer by thermal nanoimprinting is used.

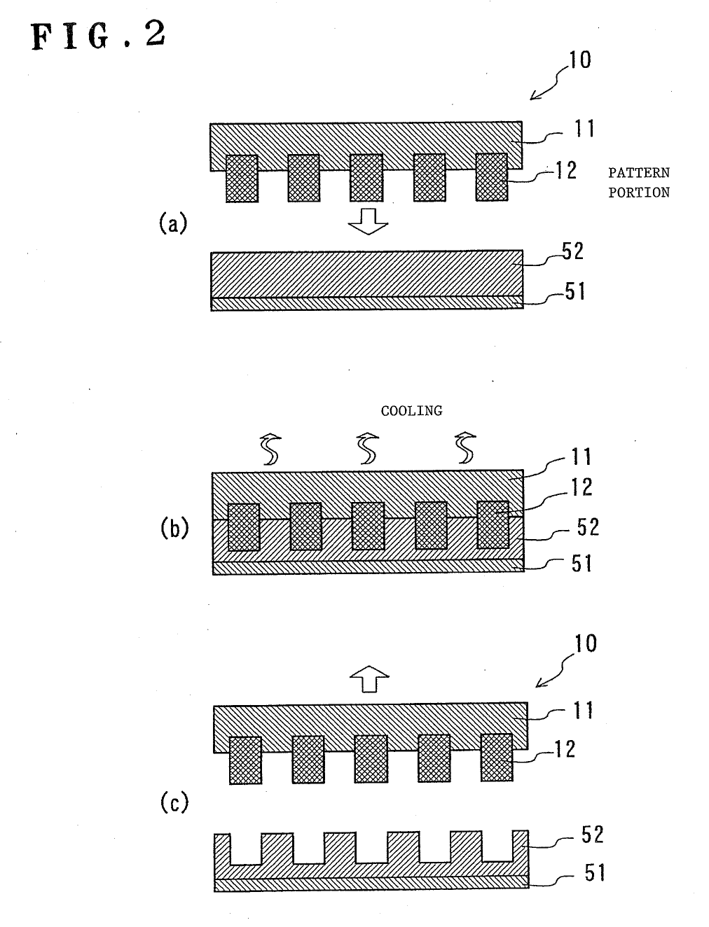

Here, a transfer method using thermal nanoimprint processing is described in summary, referring to FIG. 2A through FIG. 2C. As shown in FIG. 2A, a PMMA (polymethyl methacrylate), polycarbonate, acrylic, or other thermoplastic resin 52 is applied by spin coating or another thin film formation means onto a substrate 51 comprising Si or another semiconductor. Then, the substrate 51 with the resin 52 applied is heated to a temperature (for example 200° C.) higher than the glass transition temperature of the resin 52 (in the case of PMMA, 105° C.) to soften the resin 52. Next, as shown in FIG. 2B, the mold 10 is pressed with a pressure of for example several megapascals against the resin 52, with the face with the relief pattern formed opposing the face onto which the resin 52 is applied, to transfer the relief pattern to the resin 52. Further, with the pressed state maintained, the substrate 51 is cooled, to cause hardening of the resin 52. When hardening of the resin 52 is completed, the mold 10 is released from the resin 52 to complete the transfer, as shown in FIG. 2C.

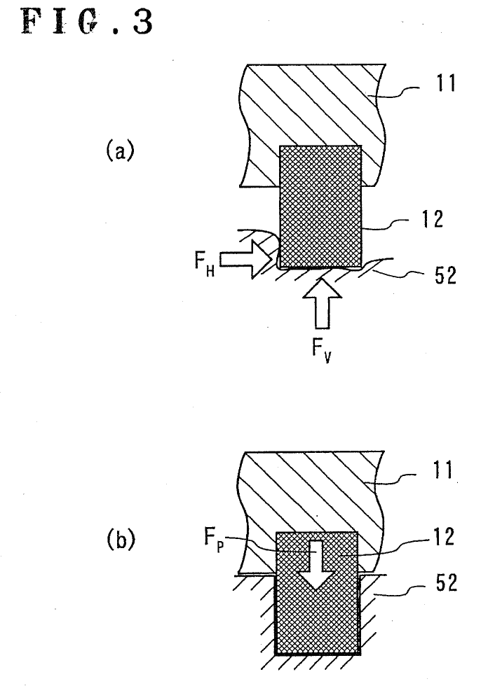

In the above-described thermal nanoimprint process, temperature changes in the range from room temperature to approximately 200° C. occur in the mold 10, so that the mold 10 must be able to withstand such temperature changes. Further, in thermal nanoimprint processes, the pattern portion 12 is pressed against the molten-state resin 52 to cause flowage, and by this means a relief pattern is formed in the resin 52, and so during pressing each of the protruding portions of the pattern portion 12 receives pressure from the resin. At this time, due to unevenness in the relief shape of the pattern portion 12, variation in the viscosity of the resin 52, and other local differences in the flowage conditions of the resin, asymmetrical flowage of resin 52 may occur on the right and left of protruding portions of the pattern portion 12. At this time, in addition to stress F_{V} from below, lateral-direction shear stress F_{H} also acts on each protruding portion, as shown by the arrows in FIG. 3A. Further, in the above thermal nanoimprint process, when cooling the resin 52 after pressing, due to variations in the relief shape, the thermal conductivity of the resin, and other local differences in thermal conduction conditions, asymmetry on the right and left of protruding portions in shrinkage of the resin 52 may occur. In such cases also, lateral-direction shear stress acts on each of the protruding portions.

In this way, in the above thermal imprint process, locally strong stresses act on the pattern portion 12, so that it is preferable that a material with high rigidity be used to form the pattern portion 12. For example, whereas the base portion 11 is formed from a material such as Si which has heat resistance and moreover can be finely machined, it is preferable that the pattern portion 12 be formed from tantalum, titanium nitride, silver, a platinum alloy, glass, glassy carbon, silicon carbide, SiO₂, or another material having heat resistance which moreover has high rigidity.

However, when the base portion 11 and pattern portion 12 are formed from different materials as described above, there are concerns that separation may occur at the joined surface while being used. In particular, during thermal nanoimprint processes, in addition to stresses due to temperature changes as described above, strong shear stress also acts-on the pattern portion 12 during pressing and during cooling, so that circumstances are such that separation occurs more readily. Moreover, in thermal nanoimprint processes, after resin cooling the pattern portion 12 and the resin 52 are intermeshed by a nanometer-scale relief pattern, and so a strong force F_{P} acting to pull the pattern portion 12 acts from the base portion 11 when separating the mold 10 from the resin 52, as shown in FIG. 3B.

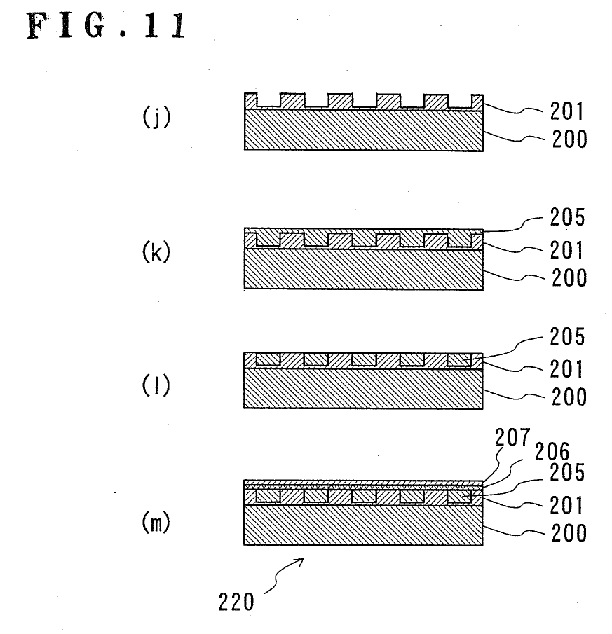

On the other hand, in the mold 10 of the first embodiment of the invention, a portion of the pattern portion 12 is buried in the base portion 11, as shown in FIG. 11, so that the area of contact of the pattern portion 12 and the base portion 11 is greater than when not buried, and moreover the joined surface of the pattern portion 12 and base portion 11 comprises faces both perpendicular and parallel to the direction of action of the pulling force, so that separation is reduced compared to cases in which the joined surface is perpendicular only.

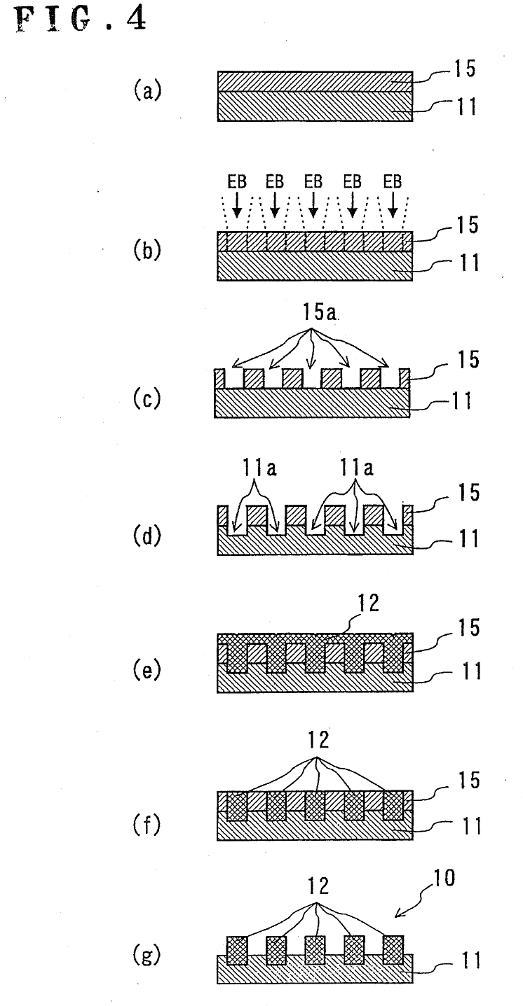

Next, a method of manufacture of the mold of the first embodiment of this invention is described, referring to FIG. 4A through FIG. 4G.

First, as shown in FIG. 4A, a spin coater or other thin film formation means is used to apply a resist 15 for electron beam exposure (for example the OEBR series by Tokyo Ohka Kogyo Co., Ltd.) onto a base portion 11 made of a heat-resistant material which can be fine-machined, such as Si. Next, as shown in FIG. 4B, an electron beam lithography device is used to irradiate the resist 15 with an electron beam EB and directly draw a pattern. Then, by developing the resist 15, a pattern 15a is formed in the resist 15, as shown in FIG. 4C. Here, the electron beam can be narrowed to a beam diameter of approximately several nm, so that relief patterns with detail dimensions of approximately 10 nm can be formed. Next, the base portion 11 is etched with the pattern 15a as a mask pattern, as in FIG. 4D, to form grooves 11a. Then, as shown in FIG. 4E, with the resist 15 left in place, CVD, sputtering, or another film deposition method is used to deposit a layer of tungsten or another high-rigidity material 12. Thereafter, the surface of the layer of high-rigidity material 12 is flattened by a flattening method such as CMP or similar, until the resist 15 is exposed, as in FIG. 4F. Finally, the resist 15 is removed, and a mold 10 of the invention is obtained, as in FIG. 4G.

After the development process shown in FIG. 4C, a thin film made of a material having a prescribed selection ratio with respect to the substrate may be layered uniformly by sputtering or another film deposition method, and thereafter, by using lift-off to remove the resist portion and the thin film thereabove, a thin film is caused to remain above the base portion 11 to form a pattern, and this pattern may be used as a mask to etch the base portion 11. In this case also, after etching steps similar to those of FIG. 4E through FIG. 4G are performed to obtain a mold; however, the position of the relief pattern of the pattern portion 12 is formed at positions inverted from those of FIG. 4G.

Further, instead of using the resist 15 as a mask to directly etch the substrate, as shown in FIG. 4D, a thin film made of a material having a prescribed selection ratio with respect to the substrate may be deposited in advance by sputtering or another film deposition method between the substrate 11 and the resist 15, and with the primary pattern 15a of the resist 15 thus formed in FIG. 4C as a mask, the thin film may be etched to form a secondary pattern, after which the secondary pattern of the thin film is used as a mask to etch the substrate 11. By this means, when etching the substrate 11, a desired selection ratio can be secured.

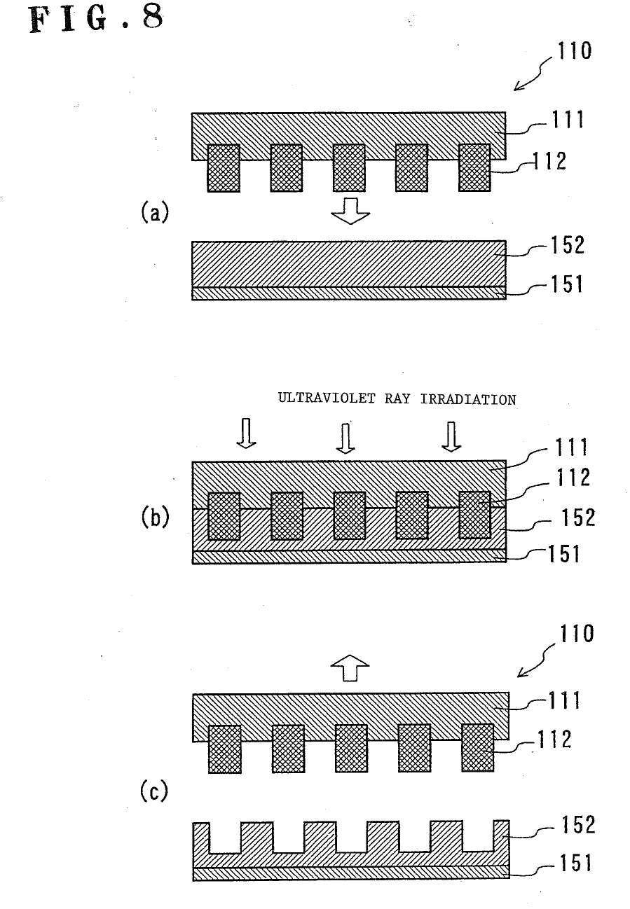

As another substitute example, during the etching of FIG. 4D, by appropriately adjusting the gas used, the temperature, pressure, and other etching conditions, the shape of the grooves 11a formed in the base portion 11 may be changed to various shapes. For example, when using a HBr—Cl₂—O₂—SF₆ system mixed gas in dry-etching of the substrate 11, by setting the flow rate fraction of the SF₆ gas low and adjusting the deposition of the side face projection film due to the etching product, the shape of the grooves formed in the base portion 21 in which the pattern portion 22 is buried can be made an inverted taper shape, or can be made a beer-barrel shape (bowing shape) such as shown in FIG. 6. By this means, the pattern portions 22, 32 are not easily separated from the base portions 21, 31 during thermal nanoimprint processes.

As described above, in the mold 10 of the first embodiment of this invention the materials of the pattern portion 12 and the base portion 11 are different, and a portion of the pattern portion 12 is buried in the base portion 11, so that the pattern portion 12 is not easily separated even during use in transfer when the molten-state resin film is a thermoplastic resin, and in particular in transfer by a thermal nanoimprint process.

### Second Embodiment

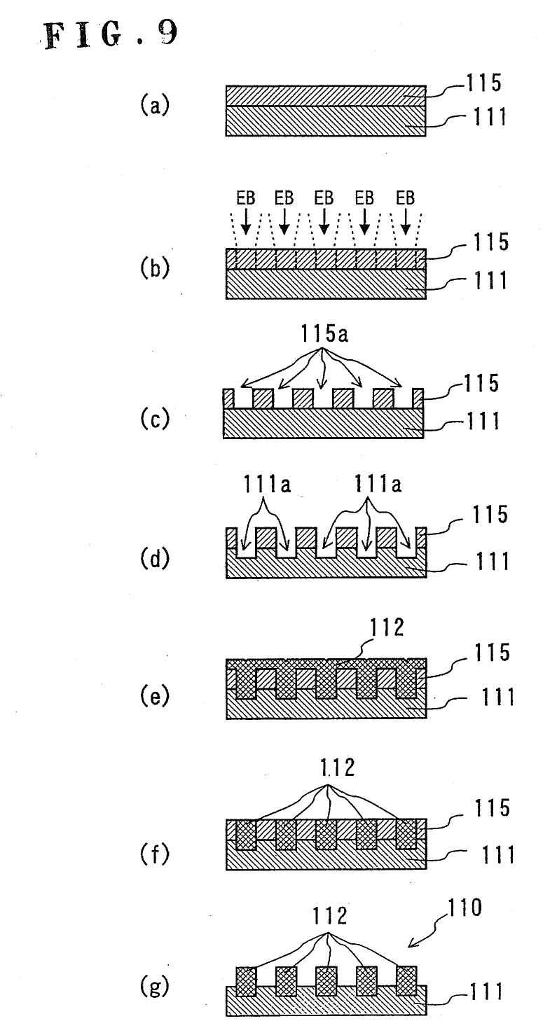

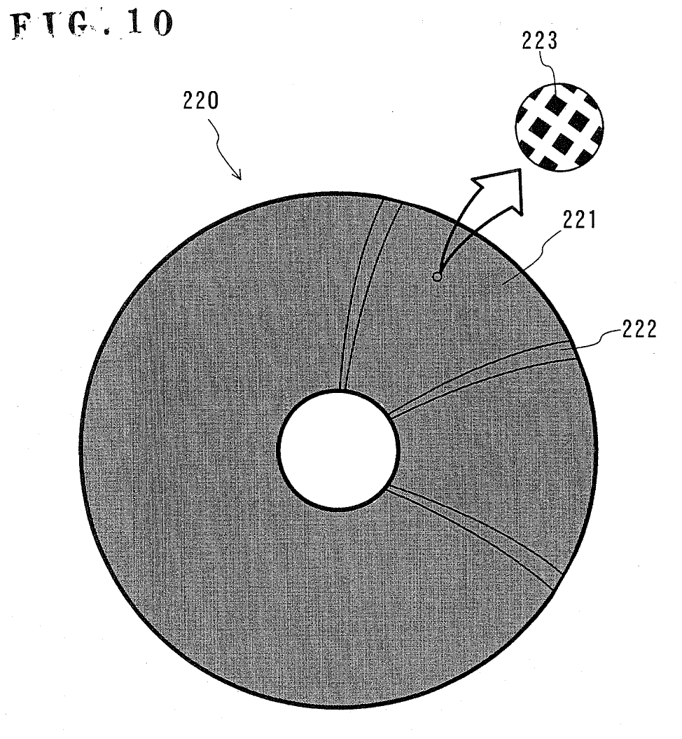

Next, the mold 110 of a second embodiment of the invention is described, referring to FIG. 7. The mold 110 comprises a base portion 111 having a flat main face, and a pattern portion 112 provided so as to protrude from the main face of the base portion 111; by this means the pattern portion 112 forms a relief shape in the main face of the base portion 111. The mold 110 of the second embodiment is characterized in being used for transfer, and in particular for transfer by photo-nanoimprint transfer methods, when the molten-state resin film is a photo-curing resin. Here, a transfer method using photo-nanoimprint processes is described in summary referring to FIG. 8A through FIG. 8C.

First, as shown in FIG. 8A, a photohardening resin 152, comprising an epoxy, silicone, polyimide, or similar, is applied by a spin coater or other thin film formation means onto a substrate 151 comprising Si or another semiconductor. Next, as shown in FIG. 8B, a mold 110 is pressed with a pressure of for example several megapascals onto the resin 152, such that the face in which is formed a relief shape is opposed to the face onto which the resin 152 is applied, to transfer the relief shape to the resin 152. Then, while maintaining the pressed state, by irradiating through the mold 110 with ultraviolet rays (ultraviolet light of wavelength 300 through 400 nm, for example), the resin 152 is hardened. Upon completion of hardening of the resin 152, the mold 110 is released from the resin 152, to complete transfer as in FIG. 8C.

As described above, in photo-nanoimprint processes, during photohardening irradiation with ultraviolet rays through the mold is performed, so that at least the base portion 111 must be formed from a material having optical transparency. Further, in photo-nanoimprint processes, lateral-direction shear stresses arising from local differences in heat conduction conditions, such as those at the protruding portions in thermal nanoimprint processes, do not occur, but during pressing, shear stresses occur arising from local differences in resin flowage conditions, similar to those in cases of thermal nanoimprint processes. Hence the pattern portion must be formed from a material which can withstand such shear stresses. In order to satisfy such conditions, in the mold of the second embodiment also, it is preferable that the base portion 111 and the pattern portion 112 be formed from different materials. For example, the base portion 111 can be formed from quartz, soda lime glass, glass, sapphire, calcium fluoride, or other materials which can be micro-machined and are optically transparent, while it is preferable that the pattern portion 112 be formed from tantalum, titanium nitride, silver, a platinum alloy, or another material with high rigidity.

Further, in the second embodiment also, similarly to the first embodiment, shear stresses during pressing and a pulling force when separating the resin from the mold 110 act, so that there are concerns that separation may occur at the joined surface due to the fact that the base portion 111 and pattern portion 112 are formed from different materials. On the other hand, in the second embodiment also, a portion of the pattern portion 112 is buried in the base portion 111 as shown in FIG. 7, so that separation does not readily occur.

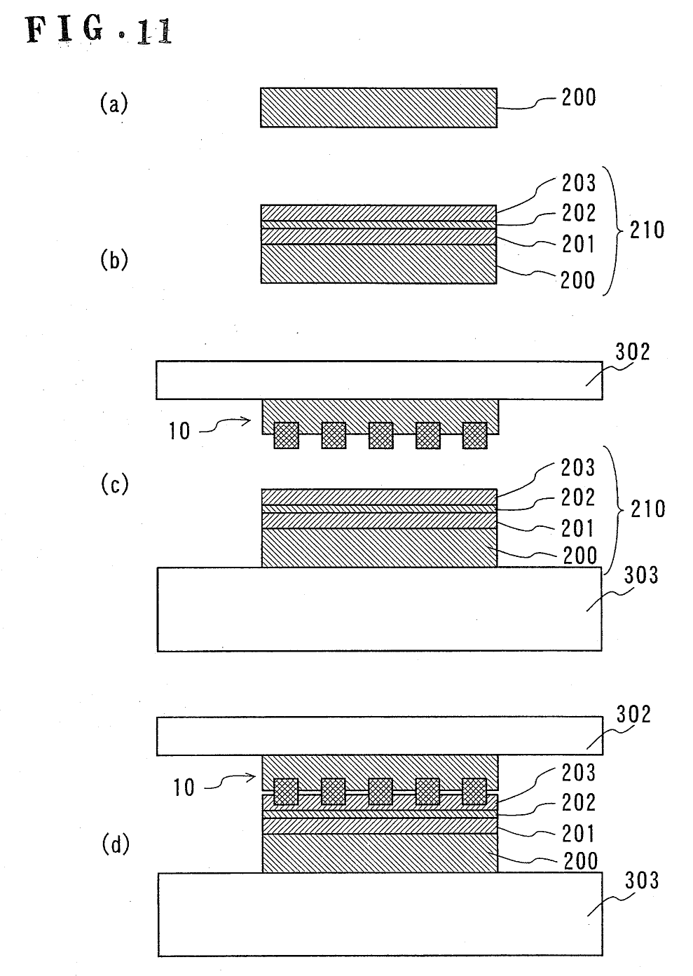

Next, a method of manufacture of the mold of the second embodiment of the invention is described, referring to FIG. 9A through FIG. 9F.

First, as shown in FIG. 9A, a spin coater or other thin film formation means is used to apply a resist 115 for electron beam exposure (for example the OEBR series by Tokyo Ohka Kogyo Co., Ltd.) onto a base portion 111 made of a heat-resistant material which is optically transparent, such as quartz. As necessary, an antistatic film or similar may be formed on the resist 115, in order to prevent charge-up effects occurring during electron beam exposure. Next, as shown in FIG. 9B, an electron beam lithography device is used to direct an electron beam EB toward and irradiate the resist 115, to directly draw a pattern. Then, by developing the resist 115, a pattern 115a in the resist 115 is formed, as in FIG. 9C. Here, the electron beam can be narrowed to a beam diameter of approximately several nm, so that a relief pattern with dimensions of approximately 10 nm can be formed. Next, the pattern 115a is used as a mask pattern to etch the base portion 111 as in FIG. 9D, to form grooves 111a. Then, as shown in FIG. 9E, with the resist 115 left in place, CVD, sputtering, or another film deposition method is used to deposit a layer of tantalum or another high-rigidity material 112. Then, the surface of the layered high-rigidity material 112 is flattened by a flattening method such as CMP or similar, to expose the resist 115 as in FIG. 9F. Finally, the resist 115 is removed, and a mold 110 of this invention is completed, as in FIG. 9G.

After the development process shown in FIG. 9C, sputtering or another film deposition method may be used to form a thin film made of a material having a prescribed selection ratio with respect to the substrate, and then, by using lift-off to remove the resist portion and the thin film thereabove, a thin film is caused to remain above the base portion 111 to form a pattern, and this pattern may be used as a mask to etch the base portion 111. In this case also, after etching steps similar to those of FIG. 9E through FIG. 9G are performed to obtain a mold; however, the position of the relief pattern of the pattern portion 112 is formed at positions inverted from those of FIG. 9G.

Rather than directly etching the substrate using the resist 115 as a mask, as in FIG. 9D, it is possible to form in advance, between the substrate 111 and the resist 115, a thin film of a material having a prescribed selection ratio with respect to the substrate such as chromium nitride or similar, using sputtering or another film deposition method, and with the primary pattern 115a of the resist 115 thus formed in FIG. 9C as a mask, the thin film may be etched to form a secondary pattern, after which the secondary pattern of the thin film is used as a mask to etch the substrate 111. By this means, when etching the substrate 111, a desired selection ratio can be secured.

As still another substitute example, during the etching of FIG. 9D, by appropriately adjusting the gas used, temperature, pressure, and other etching conditions, the shape of the grooves 111a formed in the base portion 111 can be made a variety of shapes. For example, when dry-etching the substrate 111, by setting the flow rate fraction of the etching gas to a prescribed value, the shape of the grooves formed in the base portion in which the pattern portion is buried can be made an inverted taper shape, or can be made a beer-barrel shape (bowing shape). By this means, the pattern portion is not easily separated from the base portion during nanoimprint processes.

As described above, in the mold 110 of the second embodiment of the invention, a portion of the high-rigidity pattern portion 112 is buried in the optically transparent base portion 111, so that even when used in transfer when the molten-state resin film is a photohardening resin, and in particular when used in transfer by photo-nanoimprint processes, the pattern portion 112 does not separate and fall off or become deformed.

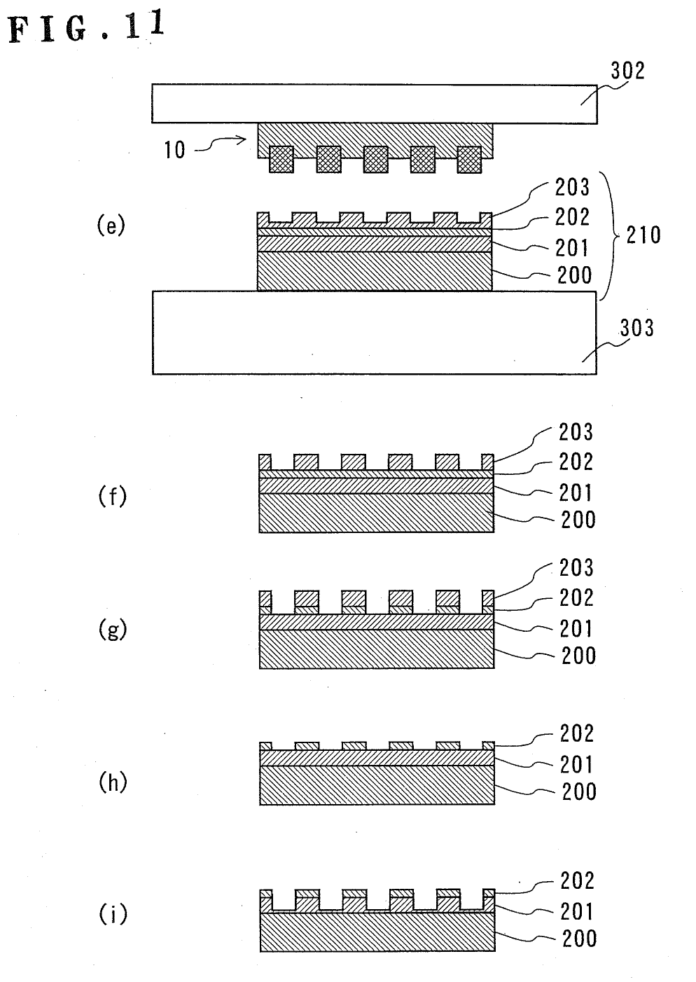

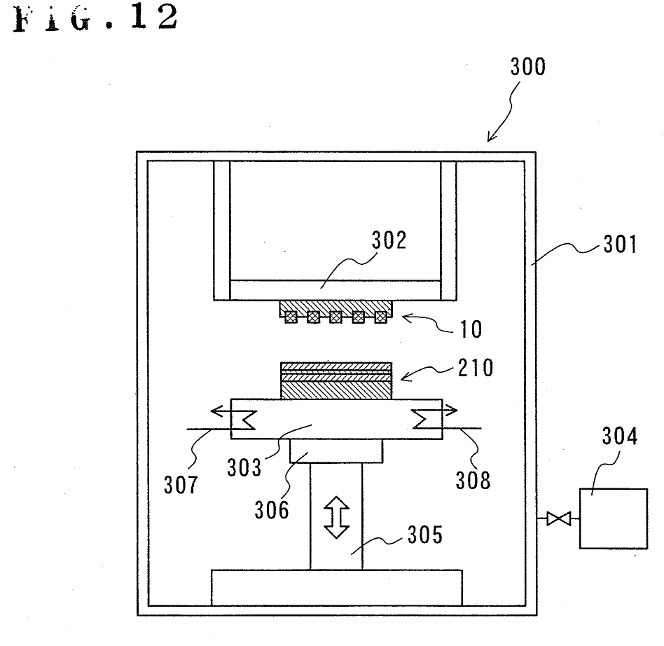

Next, a method of using the mold 10 of the first embodiment to manufacture of a hard disk or other magnetic recording media, as one example of patterned media, is described referring to FIG. 10, FIG. 11, and FIG. 12.

A so-called hard disk is magnetic recording media in which magnetic particles are arranged regularly by artificial means; theoretically, one bit can be recorded onto one magnetic particle, so that, for example, for a pattern with a bit interval of approximately 25 nm, extremely high-density recording at approximately 1 Tbpsi (Tbit/inch²) can be realized. As described above, the mold of this embodiment of the invention is capable of transferring relief patterns with dimensions of approximately 10 nm, so that such hard disks can easily be fabricated.

FIG. 10 shows an example of a pattern shape formed in such a hard disk. As shown in FIG. 10, the pattern shape formed in hard disks 220 generally comprises data track portions 221 and servo pattern portions 222. In data track portions 221, recording patterns of dot series 223 are arranged in concentric circles. In servo pattern portions 222, rectangular patterns indicating address information and track seek information, as well as line-shape patterns extending in directions traversing tracks to extract clock timing, and similar are formed.

Next, processes to manufacture the hard disk shown in FIG. 10 are described, referring to FIG. 11.

First, as shown in FIG. 11A, a base substrate 200 for the recording media, made of specially machined reinforced glass, Si wafer, aluminum plate, or similar material, is prepared.

Next, a recording film layer 201 is formed by sputtering or similar on this base substrate 200. In the case of perpendicular magnetic recording media, this recording film layer has a layered structure comprising a soft magnetic underlayer, intermediate layer, and ferromagnetic recording layer. Next, sputtering or similar is used to form a metal mask layer 202, of Ta, Ti, or another metal, on the recording film layer 201, and finally a spin coater or similar is used to deposit material for transfer 203 onto this metal mask layer 202, to form the member for transfer 210. In the case of a hard disk, for example polymethyl methacrylate (PMMA) or another thermoplastic resin is used. In FIG. 11B, an object for transfer 210 formed as described above is shown. When using the mold 110 of the second embodiment, a photohardening resin is used as the material for transfer 203. At this time, a photo-nanoimprint device is used as the nanoimprint device, described below.

Next, as shown in FIG. 1C, the member for transfer 210 described above and the mold 10 of the first embodiment of the invention are set in the thermal nanoimprint device, such that the material for transfer 203 and the relief face of the mold 10 are mutually opposed.

Here the configuration of a general thermal nanoimprint device 300 is described, referring to FIG. 12. In the thermal nanoimprint device 300, a vacuum pump 304, to remove solvent and similar from the resist during imprinting processes, is connected to the interior of the chamber 301. In the upper portion of the chamber 301 is fixed a mold support portion 302 which supports the mold 10. Opposing the mold support portion 302 is installed a stage 303, which supports the member for transfer 210. The stage 303 is mounted on an elevating device 305 driven by hydraulic means or similar; in this way, the member for transfer 210 is raised and pressed against the mold 10, so that transfer is performed. A load cell 306 is installed between the stage 303 and the elevating device 305, to measure the pressing force during transfer. Also, a heater 307 and cooler 308 are provided in the stage 303 to heat and cool the member for transfer 210.

After setting the mold 10 and the member for transfer 210 in the thermal nanoimprint device 300, the nanoimprint device 300 is started. As a result, as shown in FIG. 11D, the stage 303 is raised, and imprinting is performed according to a prescribed sequence. After imprinting has been performed, the stage 303 is lowered as shown in FIG. 11E, and transfer is completed.

Next, the member for transfer 210 to which transfer is completed is retrieved from the nanoimprint device 300, and by means of ashing using O₂ gas or similar, the remaining portion of the material for transfer 203 is removed, as in FIG. 11F. By this means, the pattern of the remaining material for transfer 203 becomes an etching mask for use in etching the metal mask layer 202.

Next, as shown in FIG. 11G, the material for transfer 203 is used as an etching mask to perform etching of the metal mask layer 202, using CHF₃ gas or similar. Then, as shown in FIG. 11H, a wet process, or dry ashing using O₂ gas or similar, is performed to remove the material for transfer 203.

Next, as shown in FIG. 11I, the metal mask layer 202 is used as an etching mask to perform etching of the recording film layer 201, by dry etching using Ar gas or similar. Then, as shown in FIG. 11J, a wet process or dry etching is used to remove the metal mask layer 202.

Next, as shown in FIG. 11K, the groove portions of the pattern formed in the surface of the recording film layer 201 by the sputtering, application, and other processes are filled with a nonmagnetic material 205 (in the case of magnetic recording media, SiO₂ or similar nonmagnetic material).

Next, as shown in FIG. 11L, etchback, chemical polishing, or similar is performed to polish and flatten the surface. By this means, a structure is fabricated in which recording material is separated by nonmagnetic material.

Finally, as shown in FIG. 11M, for example a protective film 206 and lubricating film 207 are formed on the surface of the recording film layer by an application method, dipping method, or similar, to complete the hard disk 220.

As described in detail above, by performing imprinting of a magnetic disk substrate using a mold for pattern transfer of this invention, patterned media having a highly precise pattern structure can be manufactured. Moreover, in this embodiment patterned media was used as an example, but application is not limited thereto, and for example application to discrete track media is also possible.

1. A mold for nanoimprint processes for performing pattern transfer, comprising a base portion, and a nano-scale protrusion provided so as to protrude from a main face of said base portion, wherein:
said base portion and said protrusion are made of different materials, a portion of said protrusion is buried in said base portion, and a bottom portion of the buried portion of said protrusion has an area larger than the cross-section of a protruding portion of said protrusion.

2. (canceled)

3. The mold according to claim 1, wherein said base portion is made of a heat-resistant material.

4. The mold according to claim 1 or claim 3, wherein said base portion is made of an optically transparent material.

5. (canceled)

6. The mold according to claim 1, wherein, in said base portion, the cross-section of the portion in which said protrusion is buried has an inverted taper shape.

7. The mold according to claim 1, wherein, in said base portion, the cross-section of the portion in which said protrusion is buried has a bowing shape.

8. The mold according to any one of claim 1, wherein said protrusion is made of a material including at least one of tantalum, titanium nitride, silver, a platinum alloy, glass, glassy carbon, silicon carbide and SiO₂.
